(19) United States
(12) Patent Application Publication
(10) Pub. No.: US 2006/0141419 A1
(43) Pub. Date: Jun. 29, 2006

(54) Method for treating a screw-cement retained prosthesis and adjustment for a screw-cement retained prosthesis

(76) Inventor: Young Ku Heo, Seoul (KR)

Correspondence Address: IPLA P.A., 3580 WILSHIRE BLVD., 17TH FLOOR, LOS ANGELES, CA, 90010, US

(21) Appl. No.: 10/544,958

(22) PCT Filed: Mar. 11, 2004
(86) PCT No.: PCT/KR04/00495

§ 371 Date: Aug. 8, 2005

(30) Foreign Application Priority Data
Mar. 13, 2003 (KR) 10-2003-0015619
Jan. 13, 2004 (KR) 10-2004-0002188

(51) Int. Cl. A61C 8/00

(52) U.S. Cl. 433/201.1

(57) ABSTRACT

A method for treating a screw-cement retained prosthesis and an abutment are disclosed. The method for treating the screw-cement retained prosthesis comprises the steps of implanting a fixture in an alveolar bone; engaging an abutment including a first screw hole to the fixture using a screw; providing a prosthetic appliance including a second screw hole formed correspondingly to the first screw hole; and bonding the prosthetic appliance and the abutment by interposing dental cement between the abutment and the prosthetic appliance. The present invention includes advantages of a screw retained prosthesis and a cement retained prosthesis and can solve the problems of the screw and cement retained prostheses. Furthermore, in order to easily separate and remount the bonded abutment and prosthetic appliance from the fixture, an allowance groove, which may provide an allowance space, is formed in a receiving portion.

### TECHNICAL FIELD

The present invention relates to a method for treating implant prosthesis and an abutment for the prosthesis, in detail to a method for treating implant prosthesis which is simple to treat and in which the prosthesis is easy to assemble and disassemble and an abutment for the prosthesis which is employed in treatment.

### BACKGROUND ART

A dental implant means a dental treating method or an artificial tooth structure that is formed by implanting an artificial dental root in a region where a tooth has been partially or wholly lost, causing the artificial dental root to adhere to an alveolar bone, and fixing a prosthesis or crown to the artificial dental root. Generally, the implant comprises a titanium fixture, an abutment fixed onto the fixture, an abutment screw for fixing the abutment to the fixture, and a prosthesis as an artificial tooth secured to the abutment.

The implant makes it possible to treat only an injured portion without injuring adjacent teeth or tissue around the lost teeth, retards an absorption rate of bone tissue by supporting the bone tissue, and can provides masticatory force and an aesthetic appearance equal to that of natural teeth.

As such, implants have become widely used in dental treatment methods for repairing an injured or lost tooth.

Conventional implants are divided into a screw retained prosthesis (SRP) and a cement retained prosthesis (CRP) according to a method for treating an implant.

Screw Retained Prosthesis (SRP)

The screw retained prosthesis has been used from when implants were first developed, and continue to be used today. In the screw retained prosthesis, fundamentally, a finished prosthetic appliance is fixed to an implant with a screw, and the prosthetic appliance can be easily removed or replaced since they are engaged by the screw. There are two types in the screw retained prosthesis. One is a type that is treated by integrally fixing an UCLA abutment and a prosthetic appliance to form a prosthetic assemble, then by mounting the prosthetic appliance directly to a fie, and the other one is a type that is treated by connecting a fixture and a transmucosal abutment, then by mounting a prosthetic assemble onto the transmucosal abutment, wherein the prosthetic assemble is formed by fixing an upper abutment (gold cylinder) and a prosthetic appliance.

FIG. 1a is a sectional view of a conventional screw retained prosthesis using an UCLA abutment.

Referring to FIG. 1a, a screw retained prosthesis 10 using an UCLA abutment comprises a fixture 12 implanted into an alveolar bone and an abutment 14, which is formed integrally with a prosthetic appliance 18 and disposed on the fixture 12. The prosthetic appliance 18 and the abutment 14 are integrally formed on the outside and are formed with a hole through the center.

A screw 16 is tightened through the hole to the fixture 12, so that the prosthetic appliance 18 and abutment 14 are fixed to the fixture 12.

FIG. 1b is a sectional view of a conventional screw retained prosthesis using an intermediate abutment.

Referring to FIG. 1b, the screw retained prosthesis 20 using an intermediate abutment comprises a fixture 22, an intermediate abutment 24, and an upper abutment 26, which is formed integrally with a prosthetic appliance 28 and is disposed on the intermediate abutment 24. The intermediate abutment 24 comprises a hole corresponding to a first screw 23, wherein the first screw 23 is engaged through the intermediate abutment 24 to the fixture 22, so that the intermediate abutment 24 is fixed to the fixture 22.

A second screw 25 is inserted through a hole that passes through the prosthetic appliance 28 and the upper abutment 26, and the second screw 25 is engaged to a screw hole formed on an upper portion of the first screw 23, so that the prosthetic appliance 28 and the upper abutment 26 are fixed to the intermediate abutment 24.

As shown in FIGS. 1a and 1b, ready-made articles such as the UCLA abutment 14 and the upper abutment 26, which are fitted to upper portions of the fixture or the intermediate abutment, are housed within lower portions of the finished prosthetic appliances 18, 28 and are integrally formed with the prosthetic appliances when the prosthetic appliances are cast.

A major feature of the screw retained prosthesis is that the screw hole is formed in an occlusal surface of the prosthetic appliance so that engagement between of the screw and the fixture can be adjusted through the screw hole. Therefore, the screw retained prosthesis has advantages as follows:

First, the prosthetic appliance can be easily separated and remounted, even after the prosthetic appliance is completed and mounted in an oral cavity.

The prosthetic appliance is easily repaired and remounted only if the prosthetic appliance is separated from the fixture in cases where repair or replacement of the prosthetic appliance is needed due to accidental breakage of the prosthetic appliance, the screw need to be tightened since the screw is loosened of itself, a patient undergoes the treatment and later complains of inconvenience regarding the prosthetic appliance which is mounted to the patient, and some of plural implant fixtures fail.

In such cases, the screw retained prosthesis allows the prosthetic appliance to be very easily separated. That is to say, the prosthetic appliance can be separated without damage by loosening the screw through the screw hole and remounted by tightening the screw.

Second, the screw retained prosthesis makes the treatment possible even when the distance between an implant and a tooth that faces the implant is short. For example, the UCLA abutment can only be used if the distance is 5 mm or greater.

However, the screw retained prosthesis also has serious disadvantages instead of satisfying the requisites.

Since the prosthetic appliance should be passively fitted to the fixture of an understructure, the screw retained prosthesis should be manufactured precisely up to its near completion. Therefore, the screw retained prosthesis is complicated to manufacture, and excessive manufacturing time and cost may be required.

Furthermore, if the implant is not completely manufactured and mounted, various stresses can be applied to the implant, so that the excessive stress may often bring about loss of bone around the implant or breakage of the prosthetic appliance or the implant itself.

A problem that often occurs in the screw retained prosthesis is the phenomenon that the screw becomes loose. Some reports say that the screw looseness occurs in about 25˜30% of the screw retained prosthesis. That is to say, compared with a fit implant prosthesis, an unfit implant prosthesis causes the screw to be strained and permanently deformed even by a small biting force, so that the screw is easily loosened.

In order to solve this problem, the screw retained prosthesis should be fixed by passive fit. In order to fabricate the prosthesis with the passive fit in the oral cavity, first a precise working model should be fabricated, and then the prosthesis should be precisely fabricated thereon.

In order to fabricate the exact precise working model, precise impression making, fabrication of the precise working model, and fabrication of the precise prosthetic appliance needs to be performed. However, if contraction, deformation or the like of material is considered, such work requires a high degree of expert training. Also, due to features of the fabricating processes, a great deal of time is needed for treatment and fabrication. Therefore, fabrication as well as treatment costs a great deal, and the cost of materials also increases. Thus, the screw retained prosthesis is very expensive with regard to total costs.

Cement Retained Prosthesis (CRP)

Contrary to the screw retained prosthesis, the conventional cement retained prosthesis (CRP) is treated by fixing a cement type abutment to the implant fixture with a screw, disposing a finished prosthetic appliance that is separately fabricated onto the fixed abutment, and bonding the prosthetic appliance and the abutment by interposing dental cement therebetween.

FIG. 2 is a sectional view of the conventional cement retained prosthesis.

Referring to FIG. 2, the conventional cement retained prosthesis 30 comprises a fixture 32, a cement type abutment 34, and a prosthetic appliance 38. The abutment 34 formed with a screw hole is disposed onto the fixture 32 implanted into the alveolar bone, and then is fixed to the fixture 32 by tightening a screw 36 to the fixture 32 through the screw hole.

The prosthetic appliance 38 is fitted into the fixed abutment 34, and then the abutment 34 and the prosthetic appliance 38 are bonded by interposing dental cement therebetween. Contrary to the screw retained prosthesis, after manufacturing the prosthetic appliance 38 separately from the abutment 34, the prosthetic appliance 38 and the abutment 34 are bonded with the dental cement.

Therefore, the most major feature in appearance, of the conventional cement retained prosthesis is that there is not a screw hole in the occlusal surface of the prosthetic appliance. Therefore, contrary to the screw retained prosthesis, artificial teeth are inconspicuous in appearance, so that the prosthetic appliance can be formed as natural teeth. However, once the prosthetic appliance is mounted cannot be separated by loosening a screw.

The cement retained prosthesis solves all the disadvantages of the screw retained type. That is to say, with the cement retained prosthesis, 1) the passive fit between the fixture and the prosthetic appliance can be easily achieved; 2) as a result, stress applied to the fixture when the prosthetic appliance is connected is reduced; 3) the screw does not often become loose; 4) clinical procedure and manufacturing processes are simple; 5) time can be saved; and 6) manufacturing costs are reduced.

Most of all, the greatest advantage of the cement retained prosthesis is to simply solve the problems caused from an unfit between the prosthetic appliance and the abutment by a space between them and the dental cement interposed. Contrary to the screw retained type, which requires the high degree of precision, the cement retained prosthesis is simple in its impression and manual operational processes, and achieves the passive fit between the implant and the prosthetic appliance as long as some fundamental rules are kept.

Due to the above reasons, the cement retained type is preferred to the screw retained type lately.

However, as mentioned above, the cement retained prosthesis has a disadvantage that it is not easy to separate and remount the prosthetic appliance. The sole method to separate the prosthetic appliance from the implant in the cement retained type is to apply an external force. As an example, in a case of single cement retained prosthesis, the screw may be come loose. In this case, even if using temporary cement, it is nearly impossible to remove the prosthetic appliance without damage of the screw threads or the prosthetic appliance. If a prosthesis comprises plural implants that are integrally formed, since retaining force caused by the plural implants is increased, it becomes even more impossible to remove the prosthetic appliance.

Another problem of the cement retained prosthesis is that the treatment is difficult when intermaxillary distance is short. In practice, there are many cases of the short intermaxillary distance. In this case, if using the cement retained type, the length of the abutment becomes short and due to this retaining force is reduced, so that potential for damage or loss of the prosthetic appliance is increased.

Furthermore, still another problem of the cement retained type is that it is difficult to completely remove the cement that remains in the oral cavity after bonding the prosthetic appliance with the cement. If the remaining cement is not completely removed, the remaining cement may cause the implant to fail since inflammation occurs at gingiva around the implant over a long period of time.

### DISCLOSURE OF INVENTION

As described above, advantages and disadvantages of the screw retained prosthesis and the cement retained prosthesis are summarized as follows. The screw retained prosthesis has the advantages that the prosthetic appliance is freely mounted and separated, and the treatment can be performed even with a short intermaxillary distance. However, there are some disadvantages that it is difficult to achieve a precise passive fit, the screw often comes loose, precise clinical and manual operational procedures are required, and a high cost and a long time are required.

Meanwhile, the cement retained type has many advantages of providing an easy passive fit, simple clinical and manual operational procedures, and time and cost savings. However, there are some shortcomings as follows: it is difficult to mount and separate disassemble and repair the prosthetic appliance; when the intermaxillary distance is short, ill effects may occur; it is difficult to remove the remaining cement from the oral cavity; and it is impossible to polish a border if the prosthetic appliance is not fitted flush to the border.

Therefore, one object of the present invention is to provide a tertiary prosthetic method, which can adopt and reject the advantages and solve the shortcomings of both prosthetic methods. That is to say, it is the object to provide a prosthesis treating method and an abutment which make the clinical and manual operation procedures simple; easily provide a passive fit with time and cost savings; make a screw hard to loosen; can be applied even in a short intermaxillary distance; make it easy to repair and mend the prosthetic appliance; make it easy to remove the remaining cement of subgingival; make it possible to polish the border of the prosthetic appliance; and enable the prosthetic appliance to be separated and remounted without damage whenever required.

Furthermore, another object of the present invention is to provide a method for treating an implant and an abutment wherein the abutment can be easily mounted and separated even if axial lines of the fixture and the abutment do not accord with each other.

According to a preferred embodiment of the present invention for achieving the above described objects, a method for treating the screw-cement retained prosthesis comprises implanting a fixture in an alveolar bone; engaging an abutment including a first screw hole to the fixture using a screw; providing a prosthetic appliance including a second screw hole formed correspondingly to the first screw hole; and bonding the prosthetic appliance and the abutment by interposing dental cement between the abutment and the prosthetic appliance.

The present invention has features of the cement retained prosthesis (CRP) since the prosthetic appliance and the abutment are bonded using the dental cement, and also has features of the screw retained prosthesis (SRP) since the screw can be tightened or loosened through the first and second screw holes. That is to say, since the abutment is tightened to the fixture and the prosthetic appliance is bonded onto the abutment with the cement, the treatment makes the precise passive fit possible and is quickly and simply performed. Furthermore, since the second screw hole is formed in the prosthetic appliance, it is possible to tighten and loosen the screw, so that the prosthetic appliance can be easily separated from and remounted to the fixture. Therefore, permanent cement may be used as the dental cement.

The method for treating the implant according to the present invention, which includes the advantages of the screw retained type and the cement retained type and solves the disadvantages of both the types, is referred to as a screw-cement retained prosthesis or a screw-cement retained implant, hereinafter, an SCRP implant.

Concretely, in the method for treating the SCRP implant, before the prosthetic appliance and the abutment are bonded with the dental cement, the prosthetic appliance is subjected to trial adaptation. The trial adaptation of the prosthetic appliance is the process determining whether the prosthetic appliance is fitted to the abutment, so that it is confirmed by assembling the prosthetic appliance and the abutment without dental cement.

Furthermore, before the prosthetic appliance and the abutment are bonded, the first screw hole is filled with supplementary filler such as gauze or cotton ball. As such, the supplementary filler may be used in order to prevent the first screw hole from being clogged with the dental cement such as the permanent cement, which is introduced into the first screw hole during the bonding process.

Contrary to the cement retained prosthesis (CRP), even after bonding the prosthetic appliance and abutment of the SCRP implant can be easily separated from the fixture. Since the prosthetic appliance and abutment can be separated by loosening the screw through the second screw hole, the remaining cement after the bonding process can be cleanly removed, and it is also possible to completely finish the implant treatment by polishing the border of the prosthetic appliance.

According to a preferred embodiment of the present invention for achieving the above described objects, the SCRP abutment, which is a kind of an abutment for a cement retained prosthesis used with an external fixture, comprises a screw hole formed upward and downward through an abutment body; and a receiving portion for receiving a joining projection formed on the upper end of the fixture, wherein the receiving portion comprises a sticking groove stuck to the upper end of the joining projection and an allowance groove providing an allowance space, which causes the joining projection to be easily separated from and joined to the sticking groove.

Fundamentally, the SCRP abutment according to the present invention has a structure similar to the abutment used in the cement retained prosthesis. However, it is a feature the SCRP abutment that it comprises a receiving portion that is divided into a sticking groove and an allowance groove. As an example application of the SCRP abutment with the feature of the sticking groove and the allowance groove, in addition to the conventional cement retained abutment, there is a titanium cement retained abutment, a gold cement retained abutment, a gold-plastic UCLA abutment, a plastic UCLA abutment, a temporary abutment, or the like. An impression coping of transfer copings can be also applied. In addition, all parts, which have features of the present invention and are used by joining an analogue upper portion for a manual operation and an external hexagonal-prosthesis, may be applied.

The sticking groove is stuck to a joining portion of the fixture such as the joining projection when the abutment is connected, so that the relative movement between the abutment and the fixture is limited, and it is possible to set the abutment in a predetermined direction. The sticking groove is generally formed correspondingly to hexagonal cylindrical shape of an external hexagonal-fixture. Alternatively, the sticking groove is formed in a circle corresponding to the shape of the joining groove or the joining projection of the fixture. Alternatively, the sticking groove is also formed as a non-circular shape where joining projections are formed on a circular cylinder, a polygonal cylinder, or a polygonal pyramid. When the joining projection of the fixture and the sticking groove of the abutment are formed in a non-circle, the abutment is prevented from rotating on the fixture, and the abutment can be easily repositioned.

The allowance groove is positioned at the lower portion of the sticking groove and provides an allowance space between the joining projection of the fixture and the receiving portion, so that the joining projection can be easily stuck to and separated from the receiving portion. Concretely, the allowance groove is formed with inclination from the lower end of the sticking groove in a conical shape so that entry of the joining projection can be guided, and is formed in a step shape from the lower end of the sticking groove so that a circular cylindrical or polygonal cylindrical allowance space with a dimension larger than that of the sticking groove can be provided.

It is preferable, but not limited to, that the depth of the sticking groove be between 10%˜80% of the depth of the receiving portion. If the integrated abutment and prosthetic are easily separated from the fixture while relative rotation of the abutment can be prevented, the depth of the sticking groove may be formed with a smaller or larger depth than that specified above.

The SCRP abutment structure according to the present invention is usefully employed in the case that the plural abutments are integrally bonded to a prosthetic appliance.

For example, when the plural fixtures are implanted into the alveolar bone, the plural fixtures are implanted generally slantingly at certain degrees of angles with respect to each other.

However, a SCRP prosthetic portion formed using the conventional hexagonal cement retained abutments does not have a sufficient allowance space between the abutments and the joining projections of the fixtures. That is to say, when the prosthetic portion is separated from the fixtures, the abutments should be separated in longitudinal directions to the respective receiving portions. However, since the directions of the receiving portions and joining projections do not accord with each other, the prosthetic portion is not able to separate from the fixture.

However, the SCRP prosthetic portion formed using the abutment according to the present invention can be provided with the allowance space by the allowance groove formed in the receiving portion. That is to say, when the prosthetic portion is separated from the fixture, the joining projection of the fixture frees itself from the sticking groove so that the joining projection can move within the predetermined range through the allowance groove, and the SCRP prosthetic portion can be separated from the fixture due to the allowance space which the allowance groove provides.

### BRIEF DESCRIPTION OF DRAWINGS

FIG. 1a is a sectional view of a conventional screw retained prosthesis using an UCLA abutment.

FIG. 1b is a sectional view of a conventional screw retained prosthesis using an intermediate abutment.

FIG. 2 is a sectional view of the conventional cement retained prosthesis.

FIG. 3 is a sectional view of an SCRP implant according to Embodiment 1 of the present invention.

FIGS. 4a to 4f are sectional views for explaining a method for treating the SCRP implant according to Embodiment 1.

FIG. 5a are sectional views for explaining a method for treating the SCRP implant according to Embodiment 2.

FIG. 5b is a sectional view for explaining a separating process of the SCRP implant according to Embodiment 2.

FIG. 6 is a sectional view of a SCRP prosthesis according to another embodiment of the present invention, which is similar to Embodiment 2.

FIG. 7 is a partial sectional view of an SCRP prosthesis for explaining the example of using an abutment for the SCRP prosthesis according to Embodiment 3 of the present invention.

FIG. 8 is a bottom partially cutaway perspective view of the abutment of FIG. 7.

FIG. 9 is a bottom view of the abutment of FIG. 7.

FIG. 10 is a front view for explaining engagement between the abutment and the fixture according to Embodiment 3.

FIG. 11 is a partial sectional view for explaining the example of using the abutment according to Embodiment 3, and shows an example of the treatment with the two prosthetic appliances integrally formed.

FIG. 12 is a bottom partially cutaway perspective view of an abutment according to Embodiment 4 of the present invention.

FIG. 13 is a front view for explaining the engagement between the fixture and the abutment according to Embodiment 4.

FIG. 14 is a bottom partially cutaway perspective view of an abutment according to Embodiment 5 of the present invention.

FIG. 15 is a bottom partially cutaway perspective view of an abutment according to Embodiment 6 of the present invention.

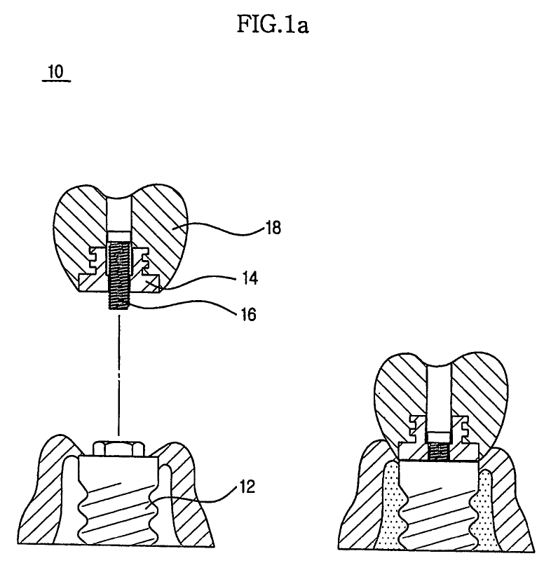

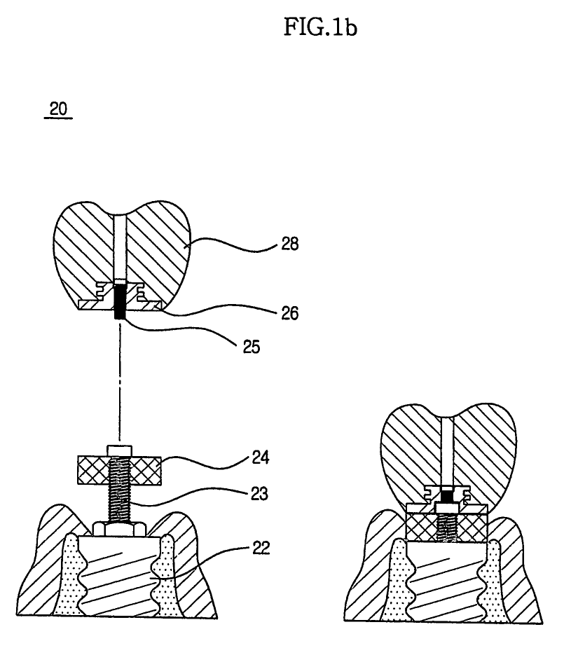

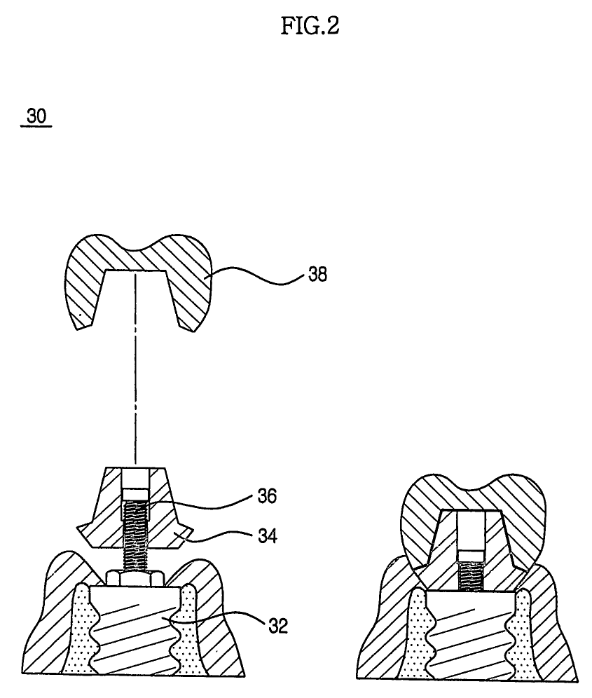

### BEST MODE FOR CARRYING OUR THE INVENTION

Though the embodiments of the present invention will be described as below referring to the accompanying drawings, the present invention is not limited or restricted by the below embodiments.

### Embodiment 1

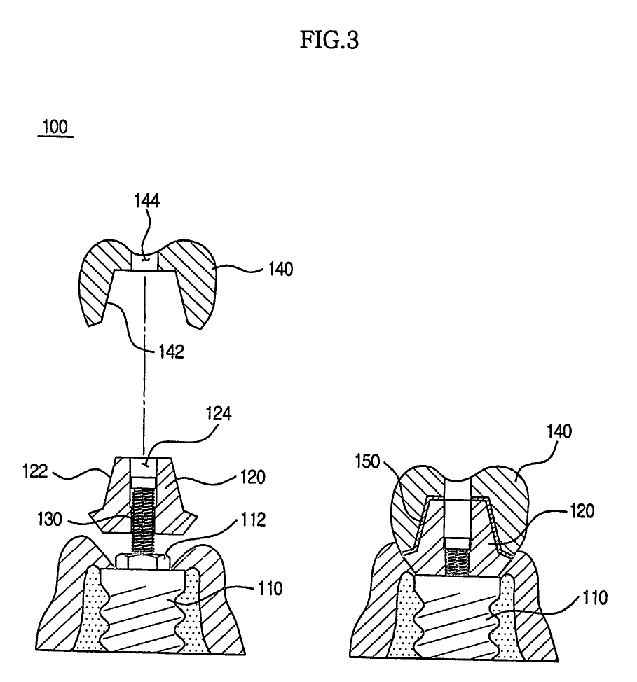

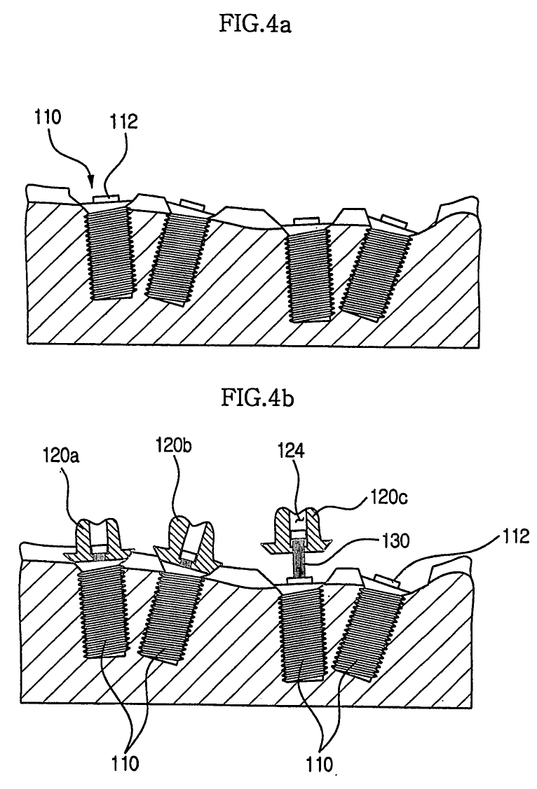

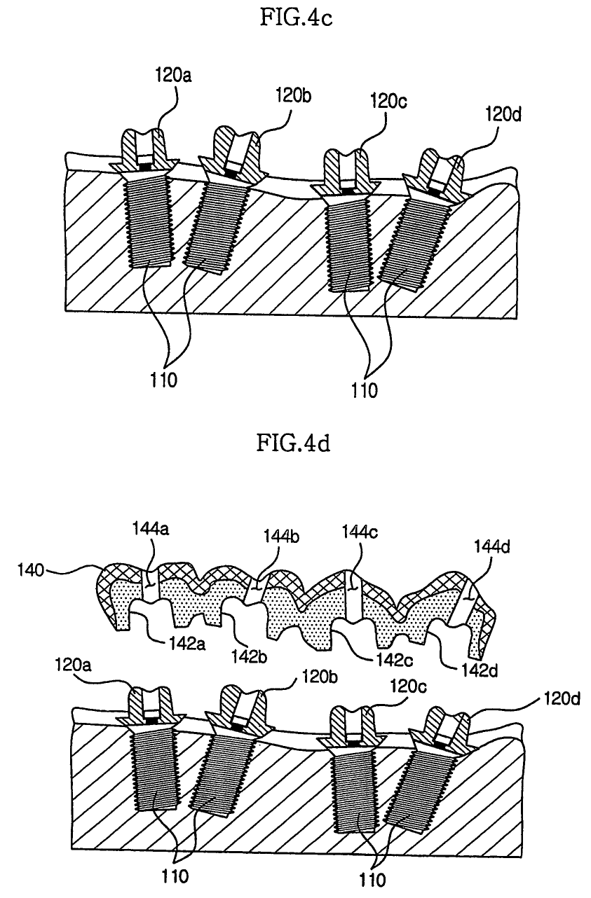

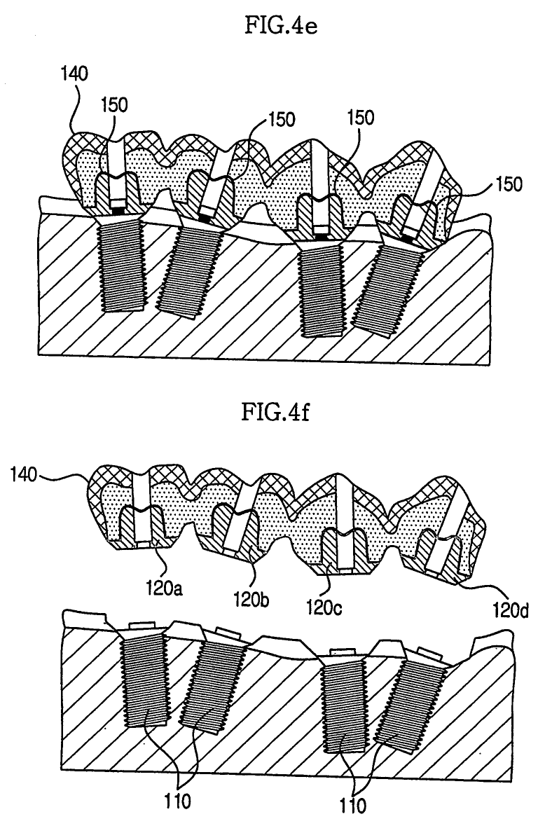

FIG. 3 is a sectional view of an SCRP implant according to Embodiment 1 of the present invention, and FIGS. 4a to 4f are sectional views for explaining a method for treating the SCRP implant according to Embodiment 1.

Referring to FIG. 3, the SCRP implant 100 according to Embodiment 1 comprises a fixture 110, an abutment 120, a screw 140 and a prosthetic appliance 150.

The fixture 110 comprises the thread 114 formed in its outer surface and is implanted along the thread 114 to the alveolar bone. The thread 114 of the implanted fixture 110 is fused with tissue of the alveolar bone and then is fixed to the alveolar bone. Generally, considerable time is needed for bonding the thread 114 and the alveolar bone to each other.

A hexagonal cylindrical joining projection 112 is formed on the upper surface of the fixture 110, in which a thread hole corresponding to a screw 130 is formed along the centerline of the joining projection 112.

An abutment 120 comprises a receiving portion for receiving the joining projection 112 and the receiving portion is formed in a hexagonal cylindrical shape, which corresponds to the shape of the joining projection 112. A first screw hole 124 is formed on the center of the abutment 120 and the screw 130 is engaged with the fixture 110 through the first screw hole 124.

Also, a prosthetic appliance 140 of an SCRP prosthesis 100 comprises a second screw hole 144. The prosthetic appliance 140 is fabricated of a two-layered structure of a metal framework and a porcelain or only metal structure and is formed with the second screw hole 144 corresponding to the first screw hole 124. The second screw hole 144 is used to separate or remount the bonded abutment 120 and prosthetic appliance 140 from or to the fixture 110 rather than to fix the abutment 120 to the fixture 110.

An outer surface 122 of the abutment 120 approximately corresponds to, but does not completely accord with, an inner surface 142 of the prosthetic appliance 140 in shape. That is to say, by providing an allowance space between the abutment 120 and the prosthetic appliance 140, the prosthetic appliance 140 is passively fitted to the abutment 120.

Dental cement 150 is interposed between the abutment 120 and the prosthetic appliance 140 so that the abutment 120 and the prosthetic appliance 140 are bonded.

The method for treating the SCRP implant 100 will be explained below referring to the accompanying drawings.

Referring to FIG. 4a, when the four fixtures 110 are implanted into an alveolar bone, the fixtures 110 are not parallel to each other and are implanted with inclination at certain angles. Therefore, the joining projections 112 formed on the upper surfaces of the fixtures 110 are directed in to different directions from each other.

Referring to FIG. 4b, each of abutments 120a, 120b, 120c is fixed to each of the fixtures 110. The abutments 120a, 120b, 120c are fixed to the fixtures 110 with the screws 130.

However, since the implanted directions of the fixtures 110 are different from each other, the prosthetic appliance 140 before processing cannot be correctly fitted to the abutments. Therefore, each of the abutments 120a, 120b, 120c should be formed with a substantially vertical stop. In order to form the vertical stop, the wall surface or margin of the abutments 120 can be partially cut or removed.

Referring to FIG. 4c, each of the abutments 120a, 120b, 120c, 120d is fixed to each of the four fixtures 110 and is formed in consideration of the implanted angle of each of the fixtures 110 and the entry angle of the prosthetic appliance 140.

Even in the oral cavity, the abutments 120a, 120b, 120c, 120d may be partially modified with a hand drill at high or low speed.

Referring to FIG. 4d, the fabricated prosthetic appliance 140 is provided. The prosthetic appliance 140 is formed by casting a framework according to a general method, and the second screw holes 144 are formed along with the framework. In order to prevent breakage of the material, a metal chimney may be formed up to an occlusal surface. However, depending on the circumstances, the metal cannot be also used around the second screw holes 144 (which is referred to as a metal free hole) from an aesthetic point of view. The framework of the prosthetic appliance 140 is adjusted for the passive fit correspondingly to the abutments 120a, 120b, 120c, 120d and is formed with inner surfaces 142a, 142b, 142c, 142d, which are different from each other.

Referring to FIG. 4e, the permanent cement 150 is interposed between the prosthetic appliance 140 and the abutments 120a, 120b, 120c, 120d so that the prosthetic appliance 140 and the abutments 120a, 120b, 120c, 120d are bonded.

Before bonding the abutments 120a, 120b, 120c, 120d to the prosthetic appliance 140, the prosthetic appliance 140 may be subjected to trial adaptation. When the prosthetic appliance 140 has been subjected to the trial adaptation, as shown in the figures, the abutments 120a, 120b, 120c, 120d may be repositioned to the fixtures 110 without the prosthetic appliance 140. Repositioning the abutments in the oral cavity may be performed due to the existence of sticking grooves of the abutments which accord with the shape of the joining projections of the fixtures.

This is one of the important features of the abutments. The reason is that each of the abutments 120a, 120b, 120c, 120d has a different form by deforming its upper structure in order to fabricate optimal prosthetic appliances. Therefore, each of the abutments 120a, 120b, 120c, 120d should be fixed to the fixture at a precise position and angle. If the abutments are fixed at inaccurate angles due to rotation, the previously fabricated prosthetic appliance 140 becomes inappropriate.

As another method, all of the abutments 120a, 120b, 120c, 120d may be fixed to the fixtures 110 at one time through the second screw holes 144 by inserting all of the abutments into the prosthetic appliance 140. There may be an abutment that would not be fixed since the prosthetic appliance 140 does not fit precisely. This problem can be solved by tighten the screw after separating only the prosthetic appliance 140 by loosening the screw and then repositioning the abutment that is not fixed to fit the sticking groove.

Tightening and loosening the screws 130 can be adjusted through second screw holes 144a, 144b, 144c, 144d. The prosthetic appliance 140 rests on the abutments 120a, 120b, 120c, 120d without any resistance, and the abutments 120a, 120b, 120c, 120d can be adjusted until the border fits completely.

After adjusting the fit between the abutments 120 and the prosthetic appliance 140 by the trial adaptation of the prosthetic appliance 140, the first screw holes 124 of the abutments 120 are filled with gauze or cotton. The reason for using the supplementary filler such as the gauze or cotton is that the first screw holes 124 are prevented from becoming clogged with the cement introduced into the first screw holes 124 when bonding the abutments 120.

Then, after interposing the permanent cement 150 between the abutments 120 and the prosthetic appliance 140, the abutments 120 and the prosthetic appliance 140 are bonded. Resin luting cement and the like may be used as the permanent cement 150.

After a lapse of certain time, the permanent cement 150 hardens so that the abutments 120 and the prosthetic appliance 140 are bonded.

Referring to FIG. 4f, after the abutments 120 and the prosthetic appliance 140 are bonded, the supplementary filler with which the first screw holes 124 are filled is removed. Then, the abutments 120a, 120b, 120c, 120d and prosthetic appliance 140 may be separated from the fixtures 110 by loosening all of the screws 130 through the first and the second screw holes 124, 144. At this time, the abutments 120a, 120b, 120c, 120d constitute a prosthesis portion by bonding them to the prosthetic appliance 140.

Contrary to the conventional cement retained prosthesis (CRP), even after bonding the abutments 120 and the prosthetic appliance 140, the prosthesis of the present invention can be separated. This is the reason why all of the screws 130 can be removed through the second screw holes 144a, 144b, 144c, 144d and a structural allowance space in the improved abutments 120 is provided.

After separating the prosthesis portion, which is constituted by the abutments 120a, 120b, 120c, 120d and the prosthetic appliance 140, the remaining cement around a gingiva and the abutments 120 can be removed and the fit can be precisely adjusted by polishing the border of the prosthetic appliance 140.

In final brief, the method for treating the SCRP implant is completed by inserting the prosthetic portion into the oral cavity, fixing the prosthetic portion to the fixture 110 with the screw 130, and closing the second screw hole 144a, 144b, 144c, 144d by filling it with plastic or ceramic material.

### Embodiment 2

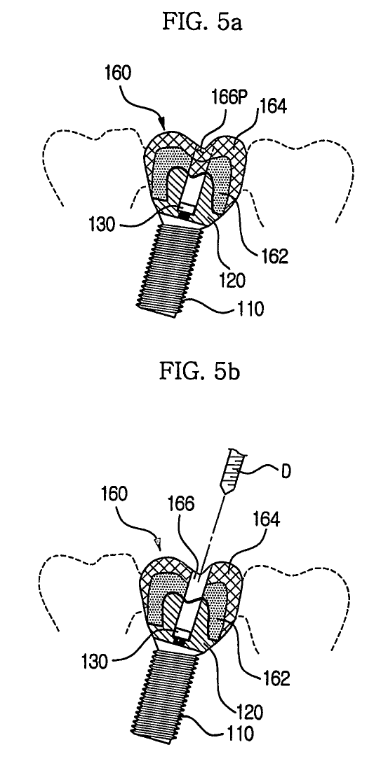

FIG. 5a is a sectional view of an SCRP implant according to Embodiment 2 of the present invention, and FIG. 5b is a sectional view for explaining a separating process of the SCRP implant according to Embodiment 2.

Referring to FIG. 5, the SCRP implant according to Embodiment 2 comprises the fixture 110, an abutment 120, the screw 130 and the prosthetic appliance 160. The fixture 110, screw 130 and prosthetic appliance 160 except the abutment 120 may refer to the explanations and drawings of Embodiment 1, and repetitional contents may be omitted.

The fixture 110, the abutment 120 and the screw 130 except a prosthetic appliance 160 may refer to the explanation and drawings of Embodiment 1, and repetitive description may be omitted.

The hexagonal cylindrical joining projection 112 is formed on the upper surface of the fixture 110, in which a thread hole corresponding to the screw 130 is formed along the centerline of the joining projection 112. The abutment 120 comprises the receiving portion for receiving the joining projection 112 and the receiving portion is formed in a hexagonal cylindrical shape, which corresponds to the shape of the joining projection 112. The first screw hole 124 is formed on the center of the abutment 120 and the screw 130 is engaged with the fixture 110 through the first screw hole 124.

The prosthetic appliance 160 is fabricated of a two-layered structure of a metal framework 162 and a porcelain 164. The metal framework 162 is formed with a hole corresponding to the first screw hole 124, and the porcelain 164 is formed on the metal framework 162 in the form of a tooth. Generally, although the conventional prosthetic appliance has a structure of a metal framework and a porcelain, the hole is not formed in the metal framework. Contrary to this, in the prosthetic appliance 160 of the SCRP prosthesis according to the present embodiment, the metal framework 162 is formed with the hole. Since the layer of the porcelain 164 is formed on the metal framework 162 with the hole formed, immediately after treatment, since a portion 166P corresponding to the second screw hole is not exposed, an aesthetic appearance can be achieved, and foreign body sensation immediately after the treatment can be considerably reduced.

Furthermore, a second screw hole 166 may be formed hereafter by using a delicate drill D, so that the screw 130 can be easily separated through the first and the second screw holes 124, 166. The treatment method of the present embodiment, which is a modification of the treatment method of the SCRP prosthesis according to Embodiment 1, has the feature that the second screw hole 166 is formed hereafter.

By forming the second screw hole 166, the bonded abutment 120 and prosthetic appliance 140 can be easily separated from the fixture 110, and the abutment 120 and prosthetic appliance 140 can be also easily remounted to the fixture 110.

The outer surface 122 of the abutment 120 approximately corresponds to, but does not completely accord with, the inner surface of the metal framework 162 in shape. That is to say, like the cement retained prosthesis, by providing an allowance space between the abutment 120 and the prosthetic appliance 160, the prosthetic appliance 160 can be passively fitted to the abutment 120. At this time, the dental cement is interposed between the abutment 120 and the prosthetic appliance 160, so that the abutment 120 and the prosthetic appliance 160 are bonded.

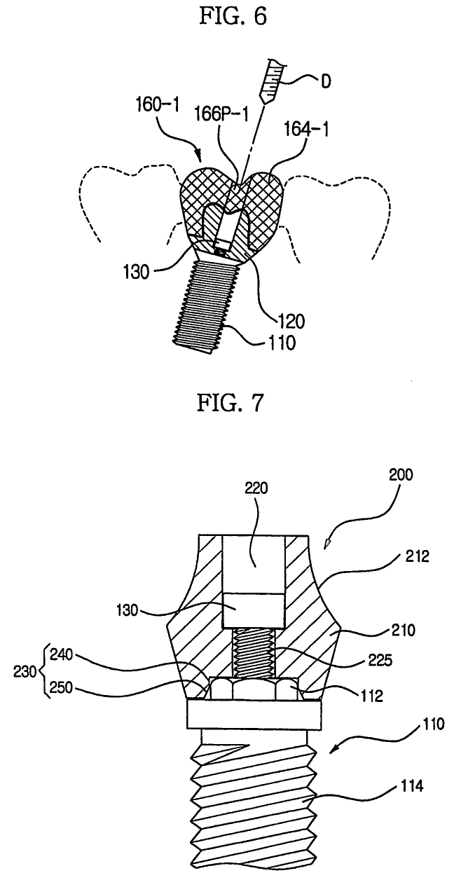

FIG. 6 is a sectional view of a SCRP prosthesis according to another embodiment of the present invention, which is similar to Embodiment 2.

Referring to FIG. 6, the SCRP prosthesis according to the present embodiment also comprises the fixture 110, the abutment 120, the screw 130 and a prosthetic appliance 160-1.

The prosthetic appliance 160-1 is constituted by a porcelain 164-1 without a metal framework. After the prosthetic appliance 160-1 of the SCRP prosthesis according to the present embodiment is bonded, since the portion corresponding to the second screw hole is not exposed, an aesthetic appearance can be achieved, and the foreign body sensation immediately after the treatment can be considerably reduced. Furthermore, a second screw hole may be formed hereafter by using a delicate drill D, so that the screw 130 can be easily separated through the first and the second screw holes. The treating method of the present embodiment, which is also modification of the treating method of the SCRP prosthesis according to Embodiment 1, has the feature that the second screw hole is formed hereafter.

### Embodiment 3

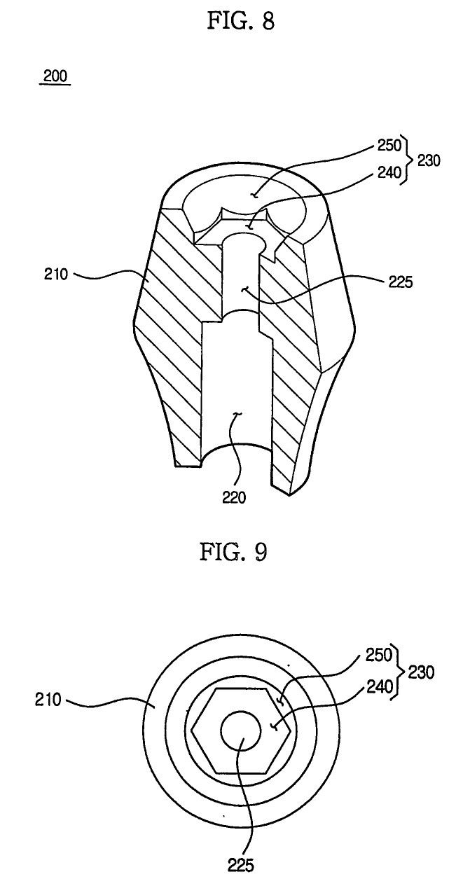

FIG. 7 is a partial sectional view of an SCRP prosthesis for explaining the example of using an abutment for the SCRP prosthesis according to Embodiment 3 of the present invention; FIG. 8 is a bottom partially cutaway perspective view of the abutment of FIG. 7; and FIG. 9 is a bottom view of the abutment of FIG. 7. A prosthesis and an abutment 200 shown in FIGS. 7 to 9 are constituted by an external connection method. Explanation regarding the fixture 110 and the screw 130 may refer to the explanation and drawings of Embodiment 1, and repetitive description may be omitted.

Referring to FIGS. 7 to 9, the prosthesis comprises the fixture 110, the abutment 200 and the screw 130.

The fixture 110 comprises a thread 114 formed on an outer surface thereof and is implanted into the alveolar bone along the thread 114. On the upper surface of the fixture 110, the hexagonal cylindrical joining projection 112 is formed. A thread hole is formed along the axial line of the joining projection 112 and the fixture 110, so that the thread hole is engaged with the thread of the screw 130.

The abutment 200 consists of an integrally formed abutment body 210, through which first screw holes 220, 225 are formed upward and downward. If diameters of the first screw holes 220, 225 are different form each other to form a step, the head of the screw 130 is supported on the step. The screw 130 is inserted into the abutment 200 through the first screw hole 220 with the larger diameter.

The lower portion of the abutment 200 is formed with a receiving portion 230 for receiving the joining projection 112 of the fixture 110, wherein the receiving portion 230 is divided into a sticking groove 240 and an allowance groove 250.

The sticking groove 240 provides a hexagonal cylindrical inner surface, the dimension of which is nearly equal to that of the joining projection 112 (but including a tolerance), so that the sticking groove 240 is stuck to the upper end of the joining projection 112. The allowance groove 250 is defined by a conical inclined surface, which is formed with inclination from the lower end of the sticking groove 240, and provides an allowance space to easily separate and remount the joining projection 112. The allowance groove 250 is extended in the form of a trumpet and may be fabricated by cutting the lower portion of a conventional hexagonal cement retained abutment into a conical shape.

The inclined surface of the allowance groove 250 is inclined at about 15 degree with respect to an outer surface of the joining projection 112. According to the present invention, it is preferable that the angle of the inclined surface is about 2 to 45 degrees. If the angle is over about 45 degrees, since a contact area between the border of the fixture 110 and the abutment 200 is too small, stability of the abutment 200 is deteriorated.

Furthermore, when the depth of the sticking groove 240 is below two-thirds of that of the receiving portion 230, the abutment 200 can be stably mounted to the fixture 110. As the sticking groove 240 becomes deeper, it becomes more difficult to mount and separate the abutment 200. If the sticking groove 240 is too shallow, the joining projection 112 and the sticking groove 240 run idle with respect to each other, so that the abutment 200 can be easily rotated. Furthermore, it may be influenced by the tolerance between the joining projection 112 and the sticking groove 240. Therefore, the depth of the sticking groove 240 should be properly maintained. According to the present invention, it is desirable that the depth of the sticking groove 240 is about 10˜80% of a depth of the receiving portion 230. In the present embodiment, a diameter of the border of the fixture 110 is about 4.1 mm; the depth of the receiving portion is about 0.7˜1.0 mm; and the depth of the sticking groove 240 is about 0.1˜0.6 mm. According to another constitution of the fixture, a diameter of the border may be variously adjusted to about 5.0 mm, 5.5 mm, 6.0 mm and the like, so that the dimensions of the receiving portion and the sticking groove can be also variously changed.

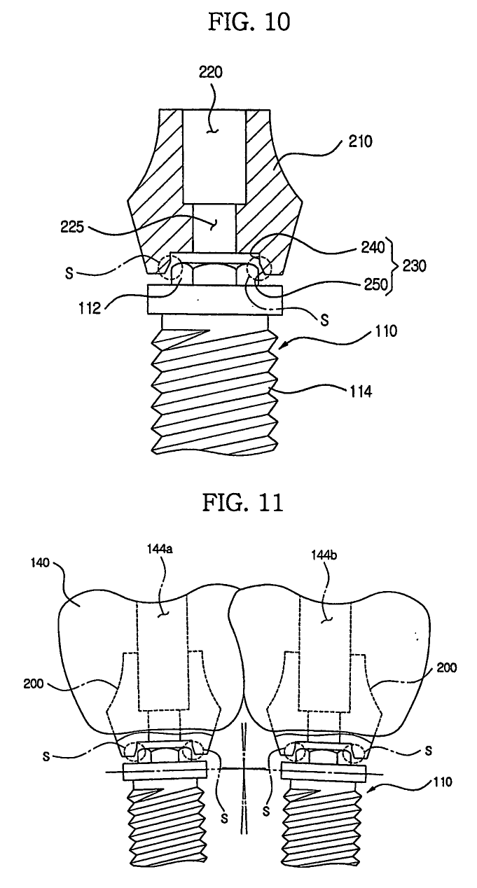

FIG. 10 is a front view for explaining engagement between the abutment and the fixture according to Embodiment 3.

Referring to FIG. 10, when the prosthetic appliance 140 and abutment 200 are separated from the fixture 110, the upper end of the joining projection 112 frees itself from the sticking groove 240 so that an allowance space S is generated around the joining projection 112. Due to such an allowance space S, the receiving portion 230 of the abutment 200 can be easily separated from the fixture 110.

Furthermore, as the joining projection 112 approaches the receiving portion 230 of the abutment 200 even when the abutment 200 is remounted, the joining projection 112 is directly inserted into and then fixed to the sticking groove 240 of the receiving portion 230. However, in most cases, a portion of the joining projection 112 first contacts the inclined surface of the allowance groove 250. The joining projection 112 is guided along the inclined surface to the sticking groove 240, and the abutment 200 can be also mounted to the fixture 110.

That is to say, due to the allowance space S, the abutment 200 can be easily separated and mounted. Such a feature is obviously shown in the case of the treatment with the two or more prostheses integrally formed.

FIG. 11 is a partial sectional view for explaining the example of using the abutment according to Embodiment 3, and shows an example of the treatment with the two prosthetic appliances integrally formed.

Referring to FIG. 11, the two fixtures 110 are implanted and fixed into the alveolar bone (not shown), and the fixtures 110 are not parallel to each other and are inclined at certain angles. In the mean time, the prosthetic appliance 140 corresponding to two teeth is formed as a piece, and the abutments 200 are bonded to lower portions of the prosthetic appliance 140.

In order to separate the integrally bonded prosthetic appliance 140 and abutments 200 from the fixtures 110, the screws are removed through second screw holes 144a, 144b, and the prosthetic appliance 140 and abutments 200 are pulled at once.

As shown in the figures, the screws are removed, the allowance space S around the joining projection 112 is provided by slight movement of the abutments 200, and due to the allowance space S, the prosthetic appliance 140 and abutments 200 are easily separated from the fixture. To the contrary, the integrally formed prosthetic appliance 140 and abutments 200 are easily engaged to the fixture 110.

The conventional hexagonal abutment is advantageously repositioned at the same position of the fixture. However, under the same condition as in FIG. 11, interference of an inlet end of the receiving portion with the joining projection 112 of the fixture prevents the joining projection 112 from being separated. Thus, the joining projection 112 cannot be easily separated from the fixture 110. Of course, if the abutments and the fixtures are mutually twisted, the abutments that face in different directions from each other cannot be easily fixed to the fixtures.

Compared with this, the abutment according to the present embodiment can be easily repositioned and, as shown in FIG. 4f, is usefully applied to separating the bonded abutment and prosthetic appliance from the fixture.

### Embodiment 4

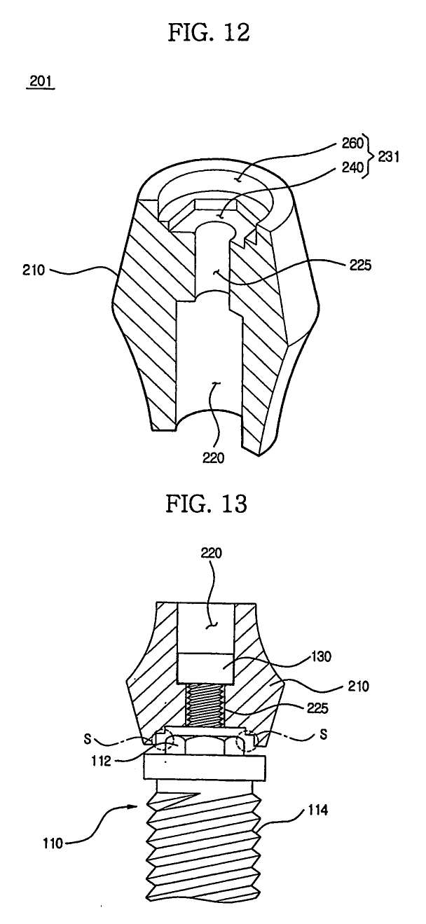

FIG. 12 is a bottom partially cutaway perspective view of an abutment according to Embodiment 4 of the present invention, and FIG. 13 is a front view for explaining the engagement between the fixture and the abutment according to Embodiment 4. An abutment 201 shown in FIGS. 12 and 13 features a cylindrical allowance groove 260. The other constitutions and functions are substantially the same as those of the previous embodiments. Therefore, the explanation of the present embodiment may refer to the explanations and drawings of the previous embodiments, and repetitive description may be omitted.

Referring to FIGS. 12 and 13, a prosthesis comprises the fixture 110, the abutment 201 and the screw 130, wherein the abutment 201 is fixed to the fixture 110 by the screw 130 that is inserted through the first screw hole 220.

The abutment 201 consists of the integrally formed abutment body 210, through which the first screw holes 220, 225 are formed upward and downward.

A lower portion of the abutment 201 is formed with a receiving portion 231 for receiving the joining projection 112 of the fixture 110, wherein the receiving portion 231 is divided into the sticking groove 240 and the allowance groove 260. The sticking groove 240 provides a hexagonal cylindrical inner surface corresponding to the joining projection 112, and is stuck to the upper end of the joining projection 112. The allowance groove 260 is formed in a step shape from the lower end of the sticking groove 240, and provides the circular cylindrical space with a dimension larger than that of the sticking groove 240. Therefore, the allowance groove 260 provides the allowance space S, which causes the joining projection 112 to be easily separated and remounted.

Compared with the inclined allowance groove 250 of Embodiment 3, the circular cylindrical allowance groove 260 may have almost the same effects.

Even in the present embodiment, when the abutment 201 is separated from the fixture 110, the upper end of the joining projection 112 frees itself from the sticking groove 240, and the allowance space S is formed around the joining projection 112. Due to the allowance space S, the receiving portion 231 of the abutment 201 can be easily separated from the fixture 110. The abutment 201 is easily remounted to the fixture 110.

### Embodiment 5

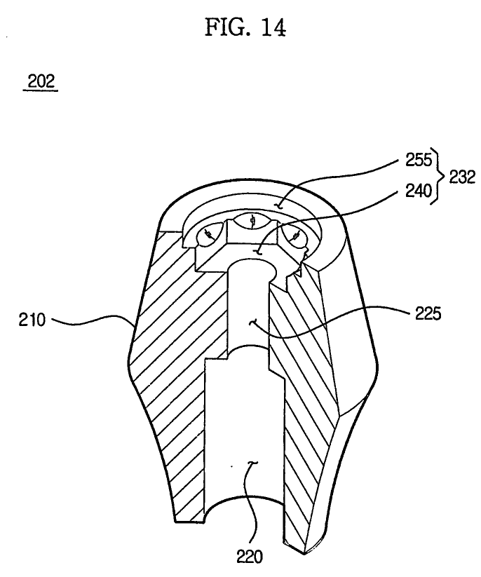

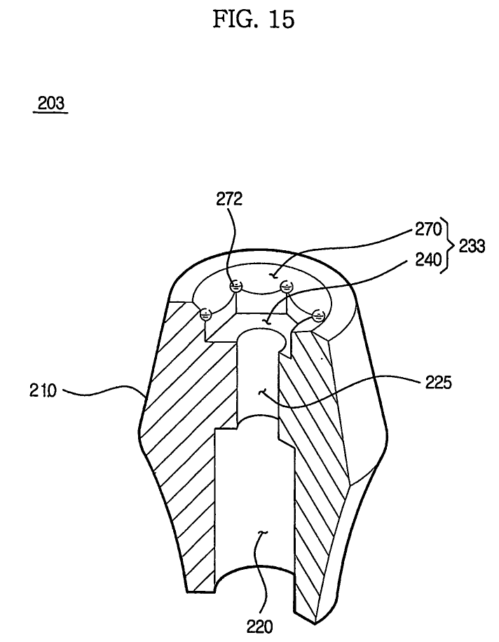

FIG. 14 is a bottom partially cutaway perspective view of an abutment according to Embodiment 5 of the present invention. An abutment 202 shown in FIG. 14 has a feature of a complex allowance groove 255 into which the inclined allowance space of Embodiment 3 and the step shaped allowance space of Embodiment 4 are effectively combined. The other constitutions and functions are substantially the same as those of the previous embodiments. Therefore, the explanation of the present embodiment may refer to the explanations and drawings of the previous embodiments, and repetitional contents may be omitted.

Referring to FIG. 14, a prosthesis comprises the fixture, the abutment 202 and the screw, wherein the abutment 202 is fixed to the fixture 110 by the screw that is inserted through the first screw hole 220.

The abutment 202 consists of the integrally formed abutment body 210, through which the first screw holes 220, 225 are formed upward and downward.

A lower portion of the abutment 202 is formed with a receiving portion 232 for receiving the joining projection of the fixture, wherein the receiving portion 232 is divided into the sticking groove 240 and the allowance groove 255. The sticking groove 240 provides a hexagonal cylindrical inner surface corresponding to the joining projection, and is stuck to the upper end of the joining projection.

The allowance groove 255 comprises partially an inclined allowance space formed in a conical shape from the lower end of the sticking groove 240 and comprises a step shaped allowance space formed in a step shape from the lower end of the inclined allowance space. The step shaped allowance space is larger than the inclined allowance space in a dimension and is formed in a circular cylindrical shape. In order to fabricate the allowance groove 255 according to the present embodiment, by forming a conical allowance groove as Embodiment 3 and then forming a circular cylindrical allowance groove as Embodiment 4, the allowance groove 255 is formed.

If an allowance groove is formed only with inclination as the allowance groove 250 of Embodiment 3, in order to form an allowance groove with a sufficient space, since the sticking groove 240 tends to be too low, an unstable engagement between the abutment and the fixture often occurs. However, by forming an upper portion of the allowance groove 255 in an inclination shape and the lower portion thereof in a step shape as in the present embodiment, the sticking groove 240 can be formed to be high and stable engagement between the abutment and the fixture can be achieved.

Even in the present embodiment, when the abutment 202 is separated from the fixture, the upper end of the joining projection frees itself from the sticking groove 240, and the allowance space is formed around the joining projection. Due to the allowance space, the receiving portion 232 of the abutment 202 can be easily separated from the fixture.

### Embodiment 6

FIG. 15 is a bottom partially cutaway perspective view of an abutment according to Embodiment 6 of the present invention. An abutment 203 shown in FIG. 15 has a feature of a receiving portion 233, which is formed with inclination as the allowance groove 250 of Embodiment 3 and comprises concave portions 272 at the connecting portion of an allowance groove 270 and the sticking groove 240. The other constitutions and functions are substantially the same as those of the previous embodiments. Therefore, the explanation of the present embodiment may refer to the explanations and drawings of the previous embodiments, and repetitive description may be omitted.

Referring to FIG. 15, a prosthesis comprises the fixture, the abutment 203 and the screw, wherein the abutment 203 is fixed to the fixture by the screw that is inserted through the first screw hole 220.

The abutment 203 consists of the integrally formed abutment body 210, through which the first screw holes 220, 225 are formed upward and downward.

A lower portion of the abutment 203 is formed with the receiving portion 233 for receiving the hexagonal joining projection of the fixture, wherein the receiving portion 233 is divided into the sticking groove 240 and the allowance groove 270. The sticking groove 240 provides the hexagonal cylindrical inner surface corresponding to the joining projection, and is stuck to the upper end of the joining projection.

The allowance groove 270 comprises an inclined allowance space formed with inclination from the lower end of the sticking groove 240 as Embodiment 3, and the joining projection can be introduced into or separated from the receiving portion 233 along the inclined allowance space. Furthermore, the concave portions 272 are partially concavely formed at portions adjacent to the inlet of the receiving portion 233 in the connecting portion of the sticking groove 240 and the allowance groove 270, that is to say, at portions where the angled corners of the sticking groove 240 meet the inclined surface of the allowance groove 270. At the portions where the concave portions 272 are formed, the sticking groove 240 is extended toward the inlet of the receiving portion 233. If the sticking groove 240 is formed to be high, the sticking groove and the joining projection interfere with each other, so that it is possible to prevent the engaging and separation of the fixture. Therefore, the concave portions 272 are partially concaved so that the joining projection can be smoothly moved.

Furthermore, if an allowance groove is formed with only an inclination as the allowance groove 250 of Embodiment 3, in order to form an allowance groove with a sufficient space, since the sticking groove 240 tends to be low, unstable engagement between the abutment and the fixture often occurs. However, by forming the allowance groove 270 with inclination and forming the concave portions 272 as in the present invention, the sticking groove 240 can be formed to be high and the stable engagement between the abutment and the fixture can be achieved.

Even in the present embodiment, when the abutment 203 is separated from the fixture, the upper end of the joining projection frees itself from the sticking groove 240, and the allowance space is formed around the joining projection. Due to the allowance space, the receiving portion 233 of the abutment 203 can be easily separated from the fixture.

### INDUSTRIAL APPLICABILITY

According to the present invention, the methods for treating the SCRP implant adopt the advantages of both of the screw retained type and the cement retained type and solve the disadvantages of both types, so that most of the conditions, which an implant prosthesis requires, are satisfied.

That is to say, with the present invention, the passive fit between the implant and the prosthetic appliance can be easily achieved; since tightening the screw can be properly adjusted, the screw does not often come loose, and can be retightened without damage to the prosthetic appliance when the screw is loosened; the prosthetic appliance is easily separated and mounted compared with the cement retained type; missing potential of the prosthetic appliance is decreased since the permanent cement can be used without a burden; and it is possible to be applied in a case of short intermaxillary distance. Furthermore, cement of subgingival can be easily removed; the border of the prosthetic appliance can be polished; the manual operational processes and clinical procedures are simple; time and cost can be considerably saved; due to fewer limitations, selection of kinds of metals for the prosthetic appliance is free; it is very advantageous in an instant treatment for the implant; it is possible to be applied to most cases; the prosthetic appliance can be separated without damage and bonded again even when the cement in one of the abutments in plural implant prostheses is weak or bad; and since a large force is not applied to the implant though the screw is strongly tightened, the screw can be tightened by the required torque even in an implant of weak ossein.

Furthermore, in the abutment according to the present invention, the sticking groove and the allowance groove are formed in the receiving portion, which is engaged to the fixture. Therefore, the abutment can be repositioned in the fixture by the sticking groove; and due to the allowance groove, even after the abutment and the prosthetic appliance are bonded, they can be easily separated from and remounted to the fixture. Especially, in the case that two or more abutments are integrally fixed to a prosthetic appliance, the allowance grooves provide the allowance spaces in order for the joining projections of the fixtures to be easily separated, and the sticking grooves guide the abutments to be positioned in the fixtures correctly.

Furthermore, since the prosthetic appliance and abutment can be easily separated from and remounted to the fixture, when the implant is broken or the screw is loosened, the implant can be easily repaired, mended and replaced.

Furthermore, since the abutment according to the present invention may be embodied on the basis of the structure of the most conventional abutment, the present invention is very economical.

As described above, though the present invention is explained referring to the preferable embodiments, it is understood by one skilled in the art that the present invention can be modified or revised without departing from the spirit or scope of the present invention described in the following claims.

1. A method for treating a screw-cement retained prosthesis, comprising the steps of:
repositioning and engaging an abutment including a first screw hole to a fixture using a screw;
providing a prosthetic appliance having a second screw hole formed correspondingly to the first screw hole; and
bonding the prosthetic appliance and the abutment by interposing dental cement between the abutment and the prosthetic appliance.

2. The method as claimed in claim 1, further comprising removing the screw through the second screw hole; separating the bonded prosthetic appliance and abutment from the fixture; removing the remaining cement; and polishing a border of the prosthetic appliance.

3. The method as claimed in claim 1, wherein a receiving portion is formed on the lower end of the abutment corresponding to a joining projection formed on an upper end of the fixture, and the receiving portion is divided into a sticking groove stuck to the upper end of the joining projection and an allowance groove providing an allowance space for the joining projection easily to move in the receiving portion, so that the prosthetic appliance can be easily separated from or stuck to the abutment by the allowance groove.

4. The method as claimed in claim 3, wherein the joining projection and the sticking groove are non-circular.

5. The method as claimed in claim 3, wherein the allowance groove is formed with inclination from a lower end of the sticking groove so that an allowance space, which is needed to separate and stick the joining projection, is provided and an entry of the joining projection is guided.

6. The method as claimed in claim 3, wherein the allowance groove is formed in a step shape from the lower end of the sticking groove, so that a circular cylindrical or polygonal cylindrical allowance space with a dimension larger than that of the sticking groove is provided.

7. The method as claimed in claim 1, wherein each of a plurality of the abutments is engaged with each of the fixtures that are implanted at predetermined intervals, and the prosthetic appliance is bonded to the abutments at once.

8. A method for treating a screw-cement retained prosthesis, comprising the steps of:
providing an implant wherein an abutment including a first screw hole is engaged with a fixture by a screw and a prosthetic appliance is bonded to the abutment;
forming a second screw hole, which corresponds to the first screw hole, on the prosthetic appliance; and
separating the prosthetic appliance and abutment from the fixture by loosening the screw through the first and the second screw holes.

9. The method as claimed in claim 8, wherein the prosthetic appliance comprises a metal framework, which is formed at a lower portion thereof and directly receives the abutment, and a porcelain, which is formed on the metal framework, and the metal framework comprises a hole corresponding to the first screw hole in order to form the second screw hole.

10. The method as claimed in claim 8, wherein the prosthetic appliance is constituted by a porcelain.

11. An abutment for a screw-cement retained prosthesis, comprising:
a screw hole formed upward and downward through an abutment body; and
a receiving portion for receiving a joining projection formed on an upper end of a fixture;
wherein the receiving portion comprises a sticking groove stuck to an upper end of the joining projection and an allowance groove providing an allowance space, which causes the joining projection to be easily separated from and joined to the sticking groove.

12. The abutment as claimed in claim 11, wherein the sticking groove is non-circular correspondingly to a shape of the upper end of the joining projection.

13. The abutment as claimed in claim 11, wherein the sticking groove is circular correspondingly to a shape of the upper end of the joining projection.

14. The abutment as claimed in claim 11, wherein a depth of the sticking groove is between 10%˜80% of the depth of the receiving portion.

15. The abutment as claimed in claim 11, wherein the allowance groove is formed with inclination from the lower end of the sticking groove so that an entry of the joining projection is guided.

16. The abutment as claimed in claim 15, wherein the inclined inner surface of the allowance groove is formed in a conical shape.

17. The abutment as claimed in claim 15, wherein the inclined inner surface of the allowance groove is formed with inclination of from 2 to 45 degrees.

18. The abutment as claimed in claim 11, wherein the allowance groove is formed in a step shape from the lower end of the sticking groove so that a circular cylindrical or polygonal cylindrical allowance space with a dimension larger than that of the sticking groove is provided.

19. The abutment as claimed in claim 11, wherein the allowance groove comprises an inclined allowance space for guiding an entry of the joining projection, formed with inclination from the lower end of the sticking groove, and a step-shaped allowance space shaped of circular cylindrical or polygonal pillar with a dimension larger than that of the inclined allowance groove, formed into a step shape from the lower end of the inclined allowance space.

20. The abutment as claimed in claim 11, wherein the sticking groove is formed in a polygonal cylindrical shape corresponding to the upper end of the joining projection; the allowance groove is formed with inclination from the lower end of the sticking groove to guide an entry of the joining projection; and portions adjacent to an inlet of the receiving portion in a connecting portion of the sticking groove and the allowance groove are partially concaved to cause the joining projection to be smoothly moved.
